(19) United States
(12) Patent Application Publication
(10) Pub. No.: US 2012/0286525 A1
(43) Pub. Date: Nov. 15, 2012

(54) METHOD FOR PRODUCING LOCK RETAINERS AND LOCK RETAINER

(76) Inventors: Bernhard Kordowski, Schwerte (DE); Thomas Waldmann, Mulheim (DE); Volker Westerwick, Bochum (DE); Holger Schiffer, Meerbusch (DE)

(21) Appl. No.: 13/519,087

(22) PCT Filed: Nov. 6, 2010
(86) PCT No.: PCT/DE2010/001303

§ 371 Date: Jun. 25, 2012

(30) Foreign Application Priority Data
Dec. 24, 2009 (DE) 10 2009 060 375.1
Mar. 17, 2010 (DE) 10 2010 011 716.1

(51) Int. Cl. B21C 23/00; E05B 15/02; B23P 17/00

(52) U.S. Cl. 292/340; 72/254; 29/527.4

(57) ABSTRACT

In order to produce a lock retainer (1) for locks, preferably motor vehicle locks, a rod-shaped raw material made of steel is first solidly shaped into the lock retainer (1) by means of cold extrusion in a plurality of sub-steps, wherein during said solid shaping process the final shape of the lock retainer (1) is produced in such a way that further processing steps can be omitted. The only remaining step then is to remove the opening (10) from the accordingly designed or shaped lock bow having the bow legs (5, 8) and to remove the retaining holes (3, 4) from the base plate (2) by means of punching or laser cutting or a similar process. The lock retainer (1) produced by means of such a method is characterized by a clear and smooth overall geometry, a surface structure (20′) being applied and optionally material being accumulated in the severely loaded areas and thus overall a lock retainer (1) not requiring further post-work being available after the sub-steps of the cold extrusion.

The invention relates to a method for producing the lock retainers of locks, preferably motor vehicle locks, in which the lock retainer comprising a base plate with retaining holes, a lock bow with two bow legs and a closing member as well as an opening, is produced as a single part and in which the opening is designed to accommodate part of the catch of the motor vehicle lock during closing of the motor vehicle door and in which the bow leg encompassed by the part is designed to correspond with the catch. The invention also relates to a lock retainer for a lock, preferably a motor vehicle lock, comprising a base plate with two or more retaining holes and a lock bow with a closing member, bow legs and an opening defined by the surrounding bow legs. Such lock retainers can be used in motor vehicle locks but also in locks of doors, gates and locking systems of buildings.

Various types of lock retainers for locks are, for instance, generally known for motor vehicle locks. DE 20 2007 012 253 A1 and DE 10 2007 041 479 A1 disclose and show a lock retainer of a motor vehicle lock, designed in such a way that it can be produced with relatively little effort. According to DE 20 2007 012 253 A1 the closing member in form of a flat strip is designed in such a way that it projects beyond the inlet area of the base plate, resulting in increased tensile strength of the locking mechanism in its closed state, i.e. in particular in case of a crash. The lock retainer consists of two parts with the retaining bolt constituting a separate part, undetachably connected to the bow and the retainer. The actual retaining bolt contains a bow serving as a collar at its end to stabilise the entire component, in order to ensure that the lock can also be opened in the event of a crash. EP 2 031 158 A2 describes a lock retainer for motor vehicle locks produced as a single piece by cold forming. Such a lock retainer is preferably produced by cold extrusion and more cost effectively than the lock retainer types described above, which generally are produced as two pieces. Considerable work is, however, still required as each individual lock retainer must be produced by a complex pressing process followed by post work. According to WO 2006/053431 A1 a lock retainer is produced by pressing and punching, which can also be produced in unusual geometries. The disadvantage of these known lock retainers is, in particular, the complex design of the individual retainer, with mostly bows being used as retaining bolts. With these known lock retainers post work, in particular, is essential in order to ensure the safe installation of the lock retainer in the motor vehicle lock and a safe operation.

The invention therefore has the task of providing a method for the simple production of a sturdy lock retainer, requiring no post work and a respective lock retainer as such.

The method solves this task by the lock retainer being produced by cold extrusion from a preferably round raw material by solid shaping said material into a T-shaped semi-finished product and thus into its principal overall geometry, whilst the retaining holes and the opening in the lock bow are subsequently punched out from the semi-finished part provided in high cold-upsetting quality.

During the implementation of such a method, a complete lock retainer is produced from a preferably round steel monolith in two to five working steps, with cold extrusion allowing the production of an overall geometry not requiring any post work. Cold extrusion is a solid-shaping process during which, in a multi-stage production process using multi-stage formers, both hollow and solid parts can be produced. The material is rendered flowable under the influence of considerable pressure, resulting in temperatures of up to 900° C. inside the object, i.e. in the lock retainer which, as already mentioned, produces a shape not requiring any post work. Surprisingly, such a method can be used to produce a lock retainer not requiring any post work but which can be installed immediately in the motor vehicle lock.

According to a further development of the method, the raw material is, prior to the cold extrusion, produced by shearing it from a round, angular or square solid bar after which it is cold extruded to a T-shaped semi-finished product representing the lock bow and base plate with the retaining holes being chamfered by punching, using one or preferably several dies. This further development of the method first of all ensures that the raw material representing the starting point of the method is always shaped the same and contains the same material in the same quantity, as it is sheared from a preferably round bar before entering the dies or cold forming process. This method treats all initial parts equally to produce a T-shaped semi-finished product containing the lock bow and base plate, which can then be formed further or is completed to form the desired lock retainer. Cold extrusion representing the principle process steps produces, as already mentioned, such T-shaped semi-finished products, not requiring any post surface work as such but which are ideally formed and shaped for further processing and, in particular, use inside the lock.

According to another further development of the method, the base plate is first formed in axial direction out of the preferably round raw material, after which the lock bow is solidly shaped in axial direction with the bow legs and without the base plate by cold extrusion in such a way that subsequently the opening in the lock bow can be produced by cold stamping whilst simultaneously producing the quadrant around the respective bow leg required for engaging the rotary latch. The retaining holes and opening are produced by punching or laser cutting. This is not post work but part of the production steps. As lock retainers are usually produced in great numbers this leads to a considerable reduction in manufacturing costs. In addition, the parts also offer a higher mechanical strength. In contrast to prior art embodiments, the final geometry of the lock retainer achieved by the method of the invention can be produced from a single piece. The different cross sections permit adjustment of the cross section shape, resulting in the final optimum overall geometry. This means that material can be reduced in areas of the lock retainer subjected to low stressing and can be accumulated in areas of the lock retainer subjected to high stressing. Particularly preferred is a sectional increase in cross section by more than 30%, for instance in the area of the bow legs. The cross section dimensions are measured in the normal direction of the surface of the lock retainer. Whilst in known lock retainers made from sheet steel, the cross section is nearly constant and equal to the thickness of the sheet steel, the end product produced by the method of the invention is better adapted to accommodate stresses due to its different cross sections.

The production steps required can be systematically reduced by the opening and retaining holes being produced during cold extrusion by means of cross inserts. During such a production step, material can be easily reduced in areas subjected to low stressing and easily accumulated in areas subjected to high stressing, resulting in the optimum lock retainer described above. The cross inserts used for producing the opening and retaining holes and subjected to extreme stressing, can be used to move “surplus” material and deposit it in the highly stressed areas of the lock retainer in order to specifically optimise the strength of the lock retainer without the need for any post work.

According to another further development of the method, a cold-upsetting steel and preferably a 33B₂ mat. no. 1.5514 with <0.009 weight % boron Rm max. 580 20 N/mm² and with preferably 0.005 weight % boron is used as round, angular or square raw material. The addition of boron facilitates cold extrusion and also ensures optimum formation of the surface across the entire component.

A cold-upsetting steel, namely a 35B₂ mat no. 1.5511 with max. 0.005 weight % boron Rm 500-650 N/mm² can also be used as round, angular or square raw material. This cold upsetting steel with the addition of boron is also ideally suited for cold extrusion and produces the advantageous properties of the component described above. Stainless steel X5CrNi1810 can also be used.

In particular where cold upsetting steel is used it is advantageous if the entire lock retainer is covered by an anti-corrosion layer after finishing and/or that grooves or edges producing a special surface structure are applied to the respective bow legs during pressing. Although anti-corrosion coating is a type of post work it is not further processing in the sense that only a layer has to be applied and no change to the overall geometry is required. The anti-corrosion layer ensures that the lock retainer produced from cold upsetting steel can carry out its function effectively in the motor vehicle lock. The applied grooves or edges or simple furrows or webs ensure an even application of the force and prevent unwanted background noise (creaking).

Furthermore a stainless steel X5CrNi1810 and preferably with 0.08-0.12% C, 1% Si and 16-20% Cr can be used as round, angular or square raw material.

A lock retainer produced according to the method of the invention comprises a base plate containing two or more retaining holes and a lock bow with an opening defined by a closing member and bow legs. This lock retainer solves the task of the invention by the base plate and the lock bow being formed as a single piece from a preferably round, rod-shaped raw material by means of cold extrusion based on the specified form of the closing member and of the bow legs as well as of the base plate and that the opening and the retaining holes are then produced by cold stamping. The result is a lock retainer, which after punching out of the retaining holes and of the opening can be used immediately without any further processing or post work. The post work savings have an important effect on the price as no additional organisational or process steps are required and, especially, as production time is reduced to a minimum. A particular advantage is that cold extrusion offers the option of specifically “weakening” material in areas of the lock retainer subjected to low stresses, whilst areas of the lock retainer subjected to high stressing can be specifically reinforced with additional material. Another advantage is that apart from no post work being required, the entire surface is provided in high cold-upsetting quality with a surface roughness of 12-18 μm. During subsequent punching, the special surface structure is then applied to the stressed bow leg.

According to the invention, the base plate and the lock bow are formed in a multi-stage press. The shearing or cutting of the raw material pieces from the solid rod material is integrated in the overall process and is, where possible, assigned to the first stage of the multi-stage press. Advantageously the material can also be cut rather than sheared. Where possible, the step of producing the opening and the retaining holes is also integrated in the multi-stage process, as the last part of such a multi-stage press. A round, rod-shaped cold upsetting steel and preferably a 33B₂ mat no. 1.5514 or a 35B₂ mat. no. 1.5511 with max. 0.005 weight % boron or stainless steel is used as raw material.

As described above, the base plate is first produced from the rod-shaped base material or raw material, after which the lock bow is produced by means of cold extrusion. For processing and, in particular, for creating the opening it is advantageous if the base plate is circular and the lock bow arises or projects from the centre of the base plate like a gate. It is then possible to produce the opening and the retaining holes in a next process step, creating the lock bow in the shape of a gate, during which, depending on the way in which the opening and retaining holes are produced, material can once again be ideally displaced, if for some reasons it could not be correctly positioned during previous process steps in the multi-stage press. All of this is possible as the high pressure generates a temperature that allows the rod material to be formed in such a way that a single-piece sturdy lock retainer is produced as the overall result of the process.

During forming of the base plate and of the bow legs and of the closing member a type of bulbous bulge is conveniently left around the bow legs, used by the invention to provide a type of base for the bow legs in the bulbous bulge on the base plate. The bulbous bulge is created during forming of the base plate and of the lock bow.

In order to achieve a good alignment with the dimensions of the surrounding components of the motor vehicle lock it is advantageous if, as provided by the invention, the closing member contains shoulders on one or both sides, sloping down towards the outer edges of the bow legs and if one or both bow legs contain a bulbous bulge. This shape also offers advantages for the production process so that for these reasons and because of the advantageous strength values such a shape is expedient. As explained above it is advantageous for material also being “displaced” inside the lock retainer by means of cold extrusion. As part of this process, material not required in areas subjected to low stressing is moved to areas subjected to high stressing, resulting for instance in the bulbous bulge on the bow legs.

A particular advantage of the invention is that it provides a method and a lock retainer produced according to this method, which allow the lock retainer to be produced as a single piece, with individual process steps being cleverly chosen to ensure that few pressing steps or working steps are required. The individual lock retainer is cut out of a solid rod-shaped material already defining the round shape of the base plate. It is thus only necessary to form the base plate and lock bow constituting a single unit from this round, rod-shaped material so that only the opening in the lock bow and the retaining holes still have to be produced. Although the method thus involves relatively few work steps, the method produces an end product, i.e. a lock retainer that can be installed immediately in, e.g. a motor vehicle lock without any further process steps. At the same time, the lock retainer offers a shape, due to the overall geometry already achieved by the production method that ensures optimum functionality both from a point of operational stressing and other operating conditions.

Further details and advantages of the object of the invention are disclosed in the below description of the associated drawing, showing a preferred embodiment with the required details and individual parts, in which:

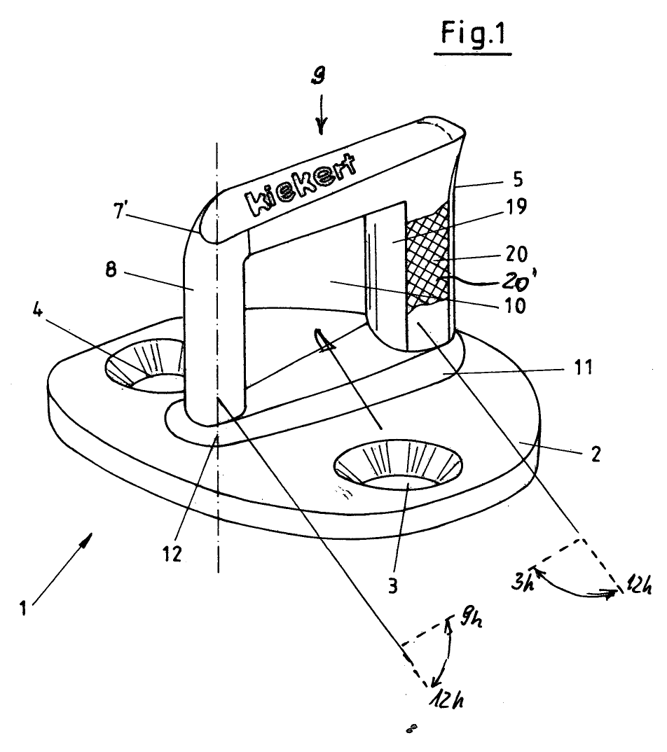

FIG. 1 shows a completed lock retainer with opening and retaining holes,

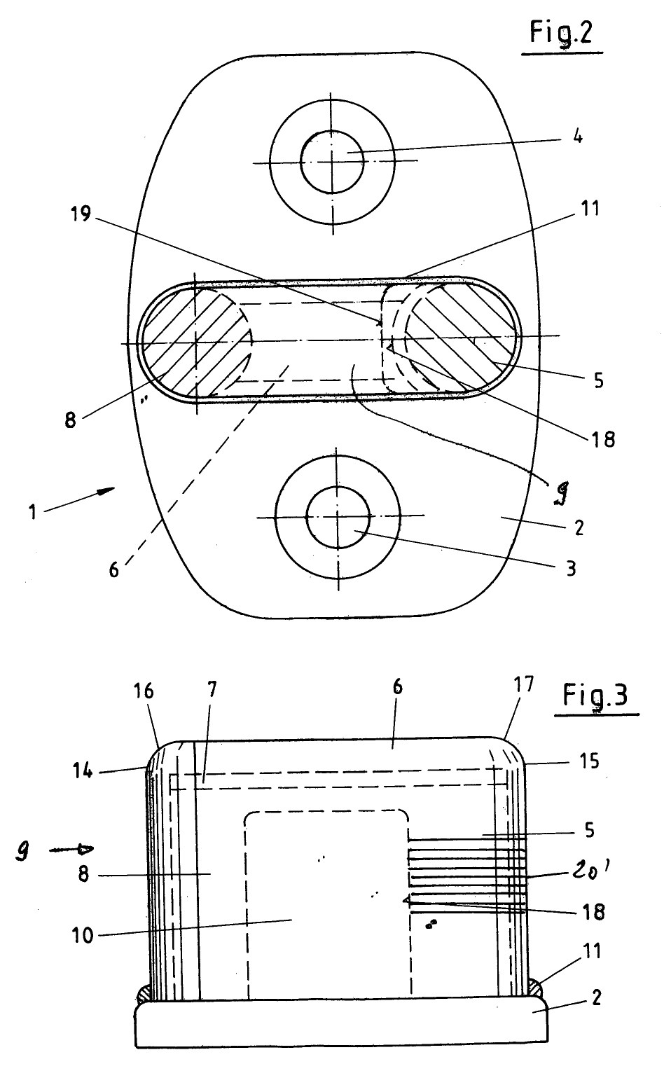

FIG. 2 represents a top view of such a lock retainer and FIG. 3 a front view.

FIG. 1 represents a perspective view of the lock retainer 1. The drawing shows that the base plate 2 is circular with the retaining holes 3, 4 being arranged at the outer periphery of the base plate 2 and in such a way that the other components projecting from the base plate 2 can also be arranged at the centre of the base plate 2. The drawing shows that the bow leg 5 has a wider design. Bow leg 5 is connected to bow leg 8 via the closing member 6, resulting in an overall reinforced lock bow. Closing member 6 and the surrounding bow leg 8 are connected to each other at their free end 7 or even merge into each other. Opening 10 is provided between bow leg 5 and bow leg 8, through which the catch (not shown) engages around bow leg 8 or 5. The drawing shows that bow leg 5 and bow leg 8 are connected with the actual base plate 2 by a type of bulbous bulge 11 or are formed out of it. This results in a wider base 12, also contributing to stabilising the entire lock retainer 1. From the widened base 12 the bow legs 5, 8 of the lock bows 9 evenly merge into the base plate 2.

According to FIG. 1, bow leg 5 contains an anti-corrosion layer 20 which is, however, only required if a material other than stainless steel is used. The anti-corrosion layer 20 is also generally applied to the base plate 2 and the lock bow 9. FIG. 1 also shows that simultaneously with the cold stamping of opening 10 and retaining holes 3, 4 the smooth quadrant (between 9 and 12 o'clock) on the surrounding bow leg 8 for the engagement of the catch (not shown) is also produced during stamping or (between 12 and 3 o'clock) on bow leg 5, if the latter engages with the catch. The special surface structure 20′, also applied during stamping, is provided for compensating for stresses in the contact area between bow leg 5 and the catch. Preferably, bow leg 8 also contains this surface structure 20′.

The diagram in FIG. 1 shows that a respective lock retainer 1 is formed by cold extrusion from a rod-shaped monolith. During a first process step this rod-shaped monolith is sheared or cut, from which in turn the base plate 2 with its predefined outer contours is formed during a first pressing step. During the next pressing step the unit consisting of bow legs 5, 8 and closing member 6 is formed with this, as mentioned above, being possible whilst retaining the connection with base plate 2, as temperatures of around 900° C. are achieved during cold forming, facilitating the respective shaping. During the last step, the opening 10 and the retaining holes 3, 4 are removed. For this, in a sense additional work step, several options are available, i.e. the opening can be punched out or burned out cut out by laser. It has already been disclosed in this specification that by using respective additional tools it is also possible to produce at least also the opening 10 during forming of the bow leg 5, 8 and closing member 6. This has the advantage that in this case the inside 19 of the bow leg 5 is provided with additional material in such a way that an overall stronger design but at the same time also a bulbous bulge 18 is achieved.

FIG. 2 represents a top view showing again that material has been accumulated on the inside 19 of the retaining bolt 5, in order to achieve this bulbous bulge 18. In this diagram, the bulbous bulge 11 is somewhat narrower and it is also noticeable that, in this case, the base plate 2 is not circular but has a somewhat oval design, as this is advantageous in certain motor vehicle locks. Generally, such a special shape is, however, not required for the base plate 2.

FIG. 3 actually shows the special shape of the closing member 6, containing shoulders 16, 17, sloping down towards the outer edges 14, 15. The diagram of FIG. 3 even shows a certain rounding which is, however, not absolutely necessary but which, as mentioned above, can also be a sloping design, facilitating installation. All in all FIG. 3 shows also, in particular, a very sturdy lock retainer 1. Again it is noticeable that bow leg 5 is wider. It contains approximately 20-40% more mass than bow leg 8. FIG. 3 also shows the bulbous bulge referenced in FIG. 1 with numeral 11, creating ultimately a type of approach radius, corresponding to the thicker material and thus the cross section of the base plate 2 in this area. Naturally, the same applies to the bulbous bulge 11 in the area of the actual retaining bolt 5, with FIG. 1 giving the impression that the bulbous bulge 11 extending between the bow leg 5 and the engaged bow leg 8 widens towards bow leg 5. This is, however, not absolutely necessary and only occurs if the diameter of bow leg 5 is greater than that of bow leg 8.

The shown lock retainer 1 is designed as a single-piece and extremely solid component in which, as already mentioned, at least 30% or even 20% of the footprint of the base plate 2 advantageously features a different cross section. Footprint refers to the top and bottom areas and not the lateral edges of the base plate 2. The diagram of FIG. 1 shows the retaining holes 3, 4 and the areas of the bulbous bulge 11 having different cross sections. During the described cold extrusion processes, the metal material is formed with limited heat, increasing its strength and load rating. Also, as already mentioned, no post treatment of the surface is required, as an already relatively high surface quality is achieved during cold extrusion. Expensive subsequent heat treatment that can also affect strength is also no longer required, reducing costs further.

In order to compensate for the loading, surface structure 20′ is applied by stamping in the contact area of the catch. Theses are furrows or webs, threads or grooves or edges on or inside the external surface of the bow leg 5, 8, reducing loading as well as unwanted noise. This surface structure 20′ is generated during punching of the opening 10 so that no separate process step is required.

All described characteristics, also those only shown in the drawings, are individually or as a whole essential to the invention.

1. A method for producing the lock retainer of a door lock, which lock retainer is produced as a single part comprising a base plate with retaining holes, a lock bow with two bow legs and a closing member as well as an opening designed to accommodate a part of the catch of the door lock during closing of a door so that the lock bow can be engaged by the catch, the method comprising:
cold extruding raw material by solid shaping said material into a T-shaped semi-finished product corresponding to the principal overall geometry of the lock retainer, and
subsequently punching out of the semi-finished product the opening in the lock bow and retaining holes.

2. The method according to claim 1, wherein prior to the cold extruding, the raw material is produced by shearing it from a round, angular or square solid bar after which it is cold extruded to form the T-shaped semi-finished product, and the retaining holes being are chamfered during punching.

3. The method according to claim 1, wherein, during cold extruding, first the base plate is formed in axial direction out of the raw material, after which the lock bow is solidly shaped in axial direction by cold extrusion in such a way that subsequently the opening in the lock bow can be produced by cold stamping whilst simultaneously producing a quadrant around the respective bow leg that is intended to be engaged by a rotary latch.

4. The method according to claim 1, wherein the opening and retaining holes are produced by cross inserts.

5. The method according to claim 1, wherein a cold-upsetting steel is used as the raw material.

6. The method according to claim 1, wherein a cold-upsetting steel, namely a 35B₂ mat no. 1.5511 with max. 0.005 weight % boron Rm 500-650 N/mm² or a stainless steel X5CrNi1810 is used as the raw material.

7. The method according to claim 6, wherein the entire lock retainer is covered by an anti-corrosion layer after completion and/or that grooves or edges producing a special surface structure are applied to the respective bow legs during stamping.

8. A lock retainer for a lock, comprising:
a base plate containing two or more retaining holes and
a lock bow with a closing member and bow legs defining an opening,
wherein the base plate and the lock bow are formed as a single piece from a raw material by cold extrusion based on the specified form of the closing member and of the bow legs as well as of the base plate and that the opening and the retaining holes then produced by cold stamping.

9. A lock retainer according to claim 8, wherein the raw material is a cold-upsetting steel, preferably a 35B₂ mat no. 1.5511 with max. 0.005 weight % boron Rm 500-650 N/mm² or a cold-upsetting steel, preferably a 33B₂ mat no. 1.5514 with <0.009 weight % boron Rm max. 580 N/mm².

10. A lock retainer according to claim 8, wherein the base plate is circular and that the lock bow arises or projects from the centre of the base plate like a gate.

11. A lock retainer according to claim 8, wherein the bow legs contain a stand in a bulge on the base plate.

12. A lock retainer according to claim 8, wherein the closing member contains shoulders on one or both sides, sloping down towards the outer edges of the bow legs and in that at least one of the bow legs contains a bulbous bulge.

13. The method according to claim 1, wherein the raw material is in the form of a round bar.
